(19) United States
(12) Patent Application Publication
(10) Pub. No.: US 2004/0240633 A1
(43) Pub. Date: Dec. 2, 2004

(54) Voice operated directory dialler

(75) Inventor: Keith Sloan, Itchen Abbas (GB)

Correspondence Address: Diana L. Roberts, IBM Corporation, IP Law Department, 11400 Burnet Road, Austin, TX, 78758, US

(73) Assignee: International Business Machines Corporation, Armonk, NY (US)

(21) Appl. No.: 10/702,985

(22) Filed: Nov. 6, 2003

(30) Foreign Application Priority Data
May 29, 2003 (GB) 0312271.0

(51) Int. Cl. H04M 11/00; H04M 1/64; G10L 15/00

(52) U.S. Cl. 379/88.16; 379/88.01; 704/231

(57) ABSTRACT

A method, apparatus, computer program product and service are described for a voice operated directory dialler. For example the method is performed in an interactive voice response system having: a dialler application; a directory of telephone numbers and names; and text baseforms comprising phonetic units estimated from the text of each of the names in the directory so that each name is associated with at least one text baseform, the method comprising: prompting a user to speak a name; recording a spoken name in electronic form; performing name recognition by estimating a recorded baseform from the recorded name to match baseforms associated with names in the directory; determining the quality of the recognition; performing the following steps if the quality of the recognition is below a predetermined level; prompting the user to spell the letters of the spoken name; performing recognition on the recorded letters to match a name in the directory; and associating the recorded baseform with the matched name whereby the matched name is associated with both a recorded baseform and a text baseform. The method further comprises dialling the number corresponding with the name in the directory.

### FIELD OF THE INVENTION

This invention relates to a method and apparatus for a voice operated directory dialler. In particular, the invention relates to an improvement when a name is not recognised and an improvement in the recognition hit rate for the directory.

### BACKGROUND OF THE INVENTION

IBM* Directory Dialler is a speech enabled application running on an interactive voice response system (IVR) having speech recognition functionality. The IVR is connected to a telephony network and prompts a telephone user for the name of the person that they wish to call. The application recognises the name, matches the name to the respective number, and transfers the call to the number for the user.

In order for the application to work it needs to extract information from a database of names and associated telephone numbers. LDAP (Lightweight Directory Access Protocol) is an Internet protocol that email clients use to look up contact information on a server. An overnight IVR process known as provisioning accesses the LDAP database to extract names and produces baseforms and grammars as needed by the speech recognition process. A baseform comprises the basic phonetic elements (for example phonemes) that make up the first name and surname of an entry. The baseforms are sometimes called the acoustic model. All the baseforms comprises all occurring phonemes in the directory. The grammar defines what combinations of first name and surname the speech recognition system will recognise and output, in this case a combination of baseforms of a name with a phone number. The grammar is sometimes called the language model.

The operation of the present IBM Directory Dialler application is shown in FIG. 2 and is described as follows. In the figures, a left pointing box is an action performed by the application and a right pointing box is an action performed by the user. The application waits, step 201, for a user to call the IVR system using a phone number indicative of the application. The application greets, step 203, the user with a welcoming message and prompts, step 205, for the name of person being called. Some variations require name and location or name and department. Once the user has spoken the name, step 207, the application attempts to recognise, step 209, the name spoken.

The speech recognition process of the prior art and the present embodiment involves breaking the speech down into n msec chunks (typically 10 msec). These chucks are then processed to produce spectral fourier values, say 64 values. The number of values is further reduced by normalising and fitting polynomial coefficients to the fourier values. By looking at adjacent chunks to provide delta and double delta coefficients, the number of coefficients is reduced to typically 39. The speech recognition system then performs pattern recognition on a group of coefficients to identify a specific phoneme. Since the accuracy is far from perfect the grammar is used to provide a best guess of a string of the most likely phonemes. The system then finds the most likely name in the directory as well as a confidence score as to how well things match.

The application compares the confidence score with an upper threshold value (x), step 211. If the confidence score is above the upper threshold value (x) then it is assumed that the user's speech has been correctly recognised and the call is immediately transferred, step 213, to the recognised destination name. Otherwise the application compares the confidence score with a lower threshold value (y), step 215. If the confidence score is below the lower threshold value (y), step 215, then the process moves to step 217 otherwise the process transfers to step 216 where the application apologises for not understanding and starts over at step 205. At step 217 the user is asked to confirm with a ‘yes’ or ‘no’ the recognised name. The user speaks a reply, step 219, and the call is then either transferred, step 221, to the appropriate number or the system prompts the user to try again and the process repeats, step 205.

Baseforms are created manually by a skilled phonetician or automatically by software rules based on the statistical properties. The latter method is used by the provisioning process but also existing baseforms created by either method may be adapted by the provisioning process. A pool of existing baseforms is used to create a set of baseforms corresponding to the known names in the directory. To supplement unknown name software rules are used to create a set of software baseforms corresponding to the text of the names in the directory. The software rules method is the more usual method of creating baseforms especially in a large database but unfortunately it is also the most error prone.

A existing approach in dictation technology is that of IBM ViaVoice* speech recognition system when it translates speech into computer text. The speech recognition system comprises a recognition engine and a database of baseforms. The recognition engine takes user speech as input and makes a best match to the baseform thereby acquiring the corresponding text. However, in the case of new user speech, such as when there is no best match for the user speech or the match is incorrect, Via Voice gives the user the option of typing in the new user text. Via Voice then associates the new user text with the new user speech and stores it as a new baseform in the baseform database. After the new word option has been completed Via Voice can match any further new user speech to the new baseform. This approach only works for a user interface including a keyboard. However, when no keyboard is present or is inaccessible then a new approach must be developed.

An existing approach in voice dialler technology is taken by a speaker-trained, voice-controlled, repertory-dialer system as described in a publication entitled ‘A voice controlled, repertory-dialer system’ by L. R. Rabine et al. published Jan. 17, 1980. The system is implemented on a computer with a high-speed processor performing real-time operations on a directory. The directory consists of seven command words, ten digits and any number of names up to a specified maximum. To train the system, the user speaks each vocabulary word twice to provide reference phonetic baseforms for the system. After training, the system can dial the telephone number corresponding to any name in the directory, or it can dial a telephone number spoken as a string of isolated digits. The system operates in two modes. In the first, the user can modify the directory either by adding or deleting names or by changing a phone number, or the user can enter the second mode using a specified command word. In the second mode, the user can speak any name in the directory or can speak a string of digits. This publication does not describe modifying an existing name with a new baseform but only deleting old names or creating new ones.

A problem with the above approach is that the directory dialler has names with a fixed baseform, if a spoken name does not match a fixed baseform then the desired number will have to be manually retrieved and dialled. Another problem in the existing directory dialler is that there is no way of modifying a name and baseform combination when the directory dialler is in use.

### DISCLOSURE OF THE INVENTION

According to a first aspect of the present invention there is provided a directory dialler method, said method being performed in an interactive voice response system having: a dialler application; a directory of telephone numbers and names; and text baseforms comprising phonetic units estimated from the text of each of the names in the directory so that each name is associated with at least one text baseform, said method comprising: prompting a user to speak a name; recording a spoken name in electronic form; performing name recognition by estimating a recorded baseform from the recorded name to match baseforms associated with names in the directory; determining the quality of the recognition; performing the following steps if the quality of the recognition is below a predetermined level; prompting the user to spell the letters of the spoken name; performing recognition on the recorded letters to match a name in the directory; and associating the recorded baseform with the matched name whereby the matched name is associated with both a recorded baseform and a text baseform.

Advantageously the method further comprises dialling the number corresponding with the name in the directory.

Most advantageously, each time the quality of the recognition is below the predetermined level, the recorded spoken name is saved and a count taken, the recorded baseform is associated with the matched name when the count reaches a second predetermined level.

Suitably the recorded phonetic baseform for a name is built from a plurality of recordings for that name. More suitably, the recorded phonetic baseform is built from an average of the closest recordings for that name and the most different recordings are not used.

According to a second aspect of the present invention there is provided a directory dialler method, said method being performed in an interactive voice response system having a dialler application and a directory of telephone numbers and names, said method comprising: prompting a user to speak a name;

recording a spoken name in electronic form; performing speech recognition on the spoken name to match a name in the directory; determining the quality of the match;

performing the following steps if the quality of the match is below a predetermined level; prompting the user to spell the letters of the spoken name;

recording spoken letters of the name in electronic form; performing recognition on the recorded letters to match with the letters of a name in the directory; dialling the number corresponding with the name in the directory.

Advantageously the method further comprising the steps of: building a text baseform from phonemes and using the text of each of the names in the directory so that each name has a corresponding text baseform; building a recorded baseform from phonemes and the spoken recorded name; and associating,the recorded baseform to the name identified by the recognised letters.

Most advantageously, each time the quality of the match is below the predetermined level, the recorded spoken name is saved and a count taken, the recorded phonetic baseform is built when the count reaches a second predetermined level.

Suitably the recorded phonetic baseform for a name is built from a plurality of recording for that name. More suitably, the recorded phonetic baseform is built from an average of the closest recordings for that name and the most different recordings are not used.

According to further aspects of the invention there are provided directory dialler systems as in claims 11 and 12.

According to further aspects of the invention there are provided computer program directory dialler products as in claims 13 and 14.

### BRIEF DESCRIPTION OF THE DRAWINGS

In order to promote a fuller understanding of this and other aspects of the present invention, an embodiment of the invention will now be described, by means of example only, with reference to the accompanying drawings in which:

FIG. 1 is a schematic diagram of the main components of the embodiment of the invention;

FIG. 2 is a schematic diagram of the method of the prior art; and

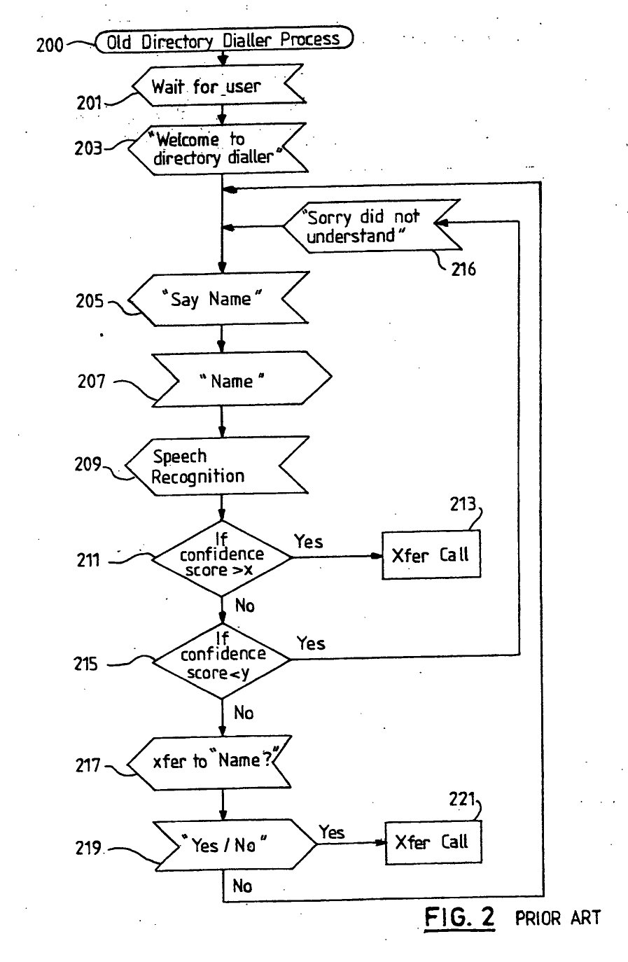

FIG. 3 is a schematic diagram of the method of the embodiment of the invention.

### DESCRIPTION OF THE PREFERRED EMBODIMENT

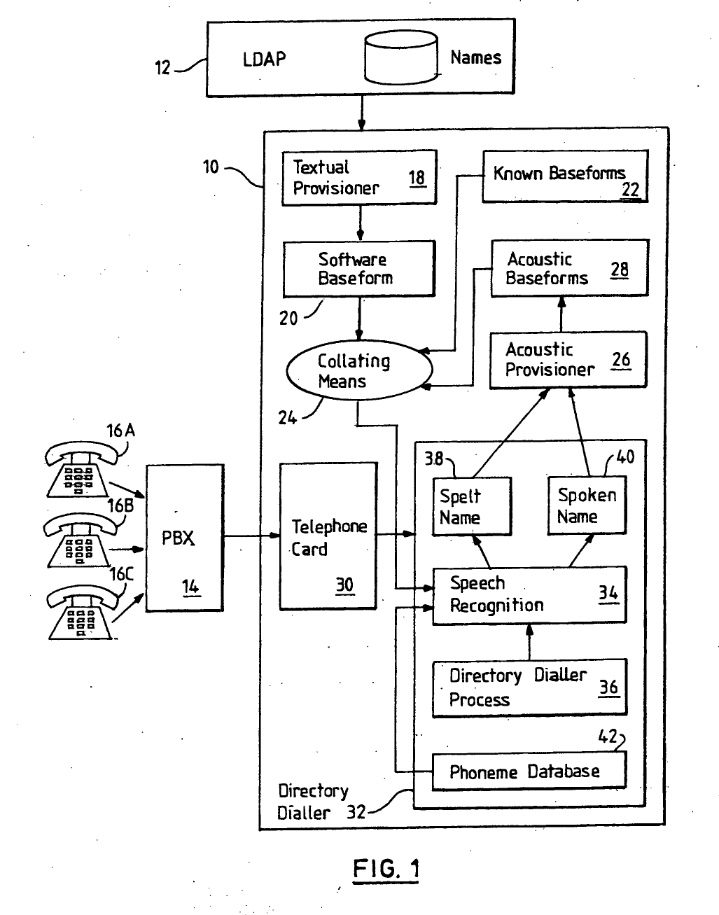

Referring to FIG. 1 there is shown a schematic diagram of the main components of the voice dialler system. The system comprising an interactive voice response system (IVR) 10 connected to an LDAP directory of names 12 and a telephony switch 14. The telephony switch 14 is connected to a telephony network represented by telephones 16A, 16B and 16C.

IVR 10 is based on an IBM WebSphere* Voice Response v5 (WVR) software and IVR telephony card hardware executing on a IBM AIX* pSeries* platform. This combination gives a scalable system capable of handling anything from a few hundred voice channels for a single IVR telephony card to a few thousand voice channels for five or more IVR telephony cards. Although WVR is the preferred IVR software any IVR software that is capable of handling speech recognition and a voice enabled directory dialler would be suitable. The LDAP directory is just one example of a directory protocol that may work in the embodiment and is particularly suitable for Internet applications where the directory is not located locally but somewhere on the Internet. The telephony network in the embodiment is the plain old telephone system (POTS) but is not so limited and a voice over IP (VoIP) telephony network or a video telephony system may equally be used. * IBM, AIX, pSeries and ViaVoice and trademarks of International Business

Machines Corporation in the United states, other countries or both.

IVR 10 comprises: a textual provisioner 18; storage 20 for software baseforms; storage 22 for known baseforms; collating means 24 for collecting the baseforms together; an acoustic provisioner 26; storage 28 for all the acoustic baseforms; a telephony card 30 and a directory dialler application 32. The directory dialler application 32 comprises: a speech recognition engine 34 controlled by a directory dialler process 36; spelt name storage 38 and spoken name storage 40. Speech recognition engine 34 uses a phoneme database 42 which is also accessible by the textual provisioner 18 and the acoustic provisioner 26 (not shown).

Textual provisioner 18 performs the conversion of the text names in the LDAP directory 12 into their phonetic equivalents using a statistical algorithm and the phoneme database 42. The provisioning process is long and not entirely accurate, the phonetic equivalents are saved to software baseform storage 20.

Software baseform storage 20 receives the phonetic names from the textual provisioner 18 and makes them available to the collating means 24.

Known baseform storage 22 is a collection of phonetic names that are already known to the system. They may be saved and updated periodically by the administrator and are made available to the collating means 24.

Collating means 24 collects all the baseforms together from the software baseform storage 20, the known baseform storage 22 and the acoustic baseform storage 28. In this embodiment it performs as a virtual storage since the data is physically stored elsewhere but in another embodiment it could perform as a physical storage unit. The baseforms in the collating means are accessed by the speech recognition engine 34 when a match is needed.

Acoustic provisioner 26 takes input from the text name storage 38, the spoken name storage 40 and performs baseform conversion of stored text names 38 using a statistical algorithm and the database of phonemes and text equivalents 42. Since this provisioning takes account of the actual spoken name 40 it will be more accurate than the textual provisioner 18.

The baseforms converted by the acoustic provisioner 26 are output to acoustic baseform storage 28 which in turn outputs to the collating means 24.

Telephony card 30 is POTS compatible and interfaces between PBX 14 and the directory dialler 32 allowing incoming and outgoing telephone calls from the application. In a Voice over IP (VoIP) embodiment the telephony card would be VoIP compatible instead but the remainder of the system would remain the same.

Directory dialler 32 contains the directory dialler process 36 and controls access to normal IVR functions as well as the speech recognition engine 34, baseform collating means 24 and acoustic provisioner 26.

In this embodiment speech recognition engine 34 is based on IBM ViaVoice although several different types of speech recognition engine are supported including both IBM ViaVoice and third party engines.

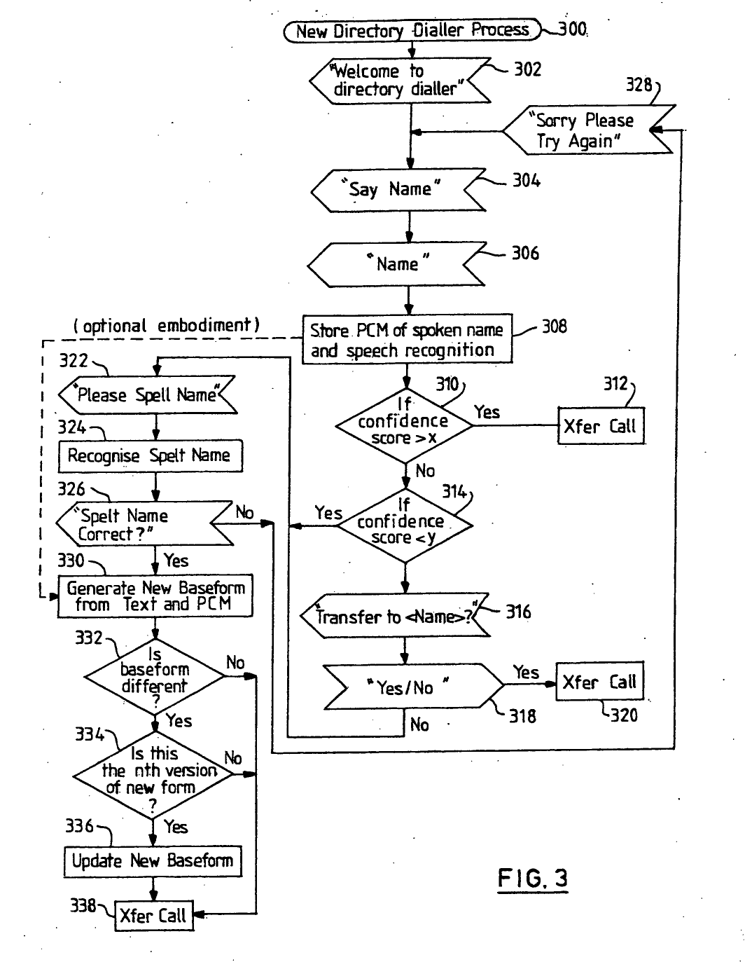

Directory dialler process 36 is the central code component which controls the directory dialler and is shown and described in more detail in FIG. 3.

Spelt name storage 38 takes output from the speech recognition unit 34 when the user is spelling a name as a string of individually spoken letters.

Spoken name storage 40 takes output from the speech recognition unit 34 and stores a whole spoken name when the engine has difficulty recognising the name. Subsequently the user will spell the name and the spelled name corresponding to the spoken name will be stored in spelt storage 38.

Phoneme database 42 provides the basic phonetic units used by the textual provisioner 18 and the acoustic provisioner 26 to create baseforms. It is also used by the speech recognition unit when performing recognition on ordinary speech not including names.

The method of the present embodiment (new directory dialler process 300) will now be described with respect to FIG. 3. New directory dialler process 300 comprises a series of sequential steps cumulating in a transfer of a call from a user to a number corresponding with a name identified by the process and the speech recognition engine 34. However, an object orientated version of the method could also be implemented.

At step 302 the user is welcomed to the process by a greeting ‘Welcome to the directory dialler’. Other instructions about using dialler may be given such as ‘please speak clearly and without hesitating’.

At step 304 the user is asked to say the name of the person he wishes to call—‘say name’.

At step 306 the user says his name and the IVR receives an electronic representation of the name, in this case the name is in a PCM (Pulse-Code Modulation) format.

At step 308 the name is stored in the spoken name repository 40 and recognition is performed by the speech recognition engine 34. In the preferred embodiment a new baseform is generated when the confidence of the recognition is within a threshold range or if requested by the user. A name is identified as the best match and a value for confidence of the match is estimated by the recognition engine. Optionally, a new acoustic baseform may be generated for each recording to improve the accuracy of the software baseform/s for a particular name. The new acoustic baseform is stored as an additional baseform for an identified name. This option is represented by the dotted line joining step 308 with step 330.

At step 310 the upper limit (x) of the confidence range is checked, if the recognition confidence is above this upper limit then the process moves to step 312 else the process moves to step 314.

At step 312 the call is transferred to the telephone number corresponding to the identified name.

At step 314 the lower level of (y) of the confidence range is checked, if the recognition confidence is below this lower limit then the process moves to step 322, else the process moves to step 316.

At step 316, where the recognition confidence is not high enough for the call to be transferred directly nor too low for the process to be automatically moved to the spelling part, the user is requested to confirm transfer to the best guessed name.

At step 318 the response of the user determines whether the call is transferred (Yes—step 320) or moved to the spelling routine (no—step 322).

At step 320 the call is transferred to the number corresponding to the identified name.

At step 322 the user is asked to spell the required name.

At step 324 the speech recognition engine 34 recognises the letters of the spelt name and identifies the name in the directory.

At step 326 the user is asked to confirm whether the name identified in the directory is correct by playing the baseform of the identified name. If the user answers ‘no’ then the process moves to step 328. Otherwise the process moves to step 330.

At step 328 the application plays a prompt to inform the user that the process must be started over ‘Please try again’.

At step 330 a new baseform is generated by the acoustic provisioner 26 using the spelt name stored in storage 38 and the spoken name recording in storage 40.

At step 332 the new acoustic baseform is checked to see if it is different from the software baseform or other identified baseform. If it is not different then the process transfers the call at step 338. Else the new baseform gets updated in the following steps.

At step 334, the process checks the version of the new baseform so that only names which have had more than a threshold number of baseforms need be updated with a new baseform at step 336. When the number of baseforms for a name is below the threshold then the call is transferred at step 338 without updating. This eliminates cases introducing new baseforms where the user coughs or makes a mistake, a new baseform is recorded but not permanently associated with a name until the threshold number of baseform has been created. When a threshold number of baseforms exist then an average is taken of the similar ones and any unique baseforms are ignored.

At step 336, the acoustic baseform database 28 is updated.

At step 338 the call is transferred to the number corresponding to the identified name.

An example is described to illustrate the invention using the name ‘Eric Janke’ which does not easily produce the correct baseform from the spelling. Text letters and words are indicated in quotes whilst phonetic letters are in capitals. The baseform phonetics for “Eric” are EH R IX KD. Given the surname Janke which is pronounced “Yanker” a software produced baseform would look like JH AE NG K IY where as a correct/hand crafted version from a phonetician that knew the correct pronunciation would be Y AE NG K AX or Y AE NG K AXR.

The user dials the number for the directory dialler system. The system prompts the user for the name to whom the user wishes to be transferred “Say Name” (step 302). The user speaks the Name in this case “Eric Janke” pronounced more like “Eric Yanker” (step 306). The system stores the utterance in a PCM file (step 308) and performs recognition on the utterance. As the baseform created by the software provisioning ( JH AE NG K IY ) does not match the utterance the system returns a poor confidence score. As a result of the poor confidence score the user is offered the chance to spell the name “Please Spell Name” (step 322). The user spells the Name “E R I C J A N K E” and the system uses a spelling baseform to try an recognise the spelling (step 324).

The parts of the baseform being used

E: IY

R: AA

I: AY

C: S IY

J: JH EY

A: EY

N: EH N

K: K EY

E: IY

And the grammar being

ERIC JANKE: E R I C J A N K E

The system will recognise the spelling. At this point we now know the name of person the user wishes to transfer to and have a example of how the name is pronounced in the stored PCM file. We can now give the software a much better chance of creating a correct baseform, as the software can consider a large number of hypotheses as to how the name is pronounced which can all be tested against the spoken example in the PCM file. The system can now arrive at a better baseform namely “Y AE NG K AXR”.

While it is understood that the process software which consists of the voice dialler application may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software is sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

The process software which consists of the voice dialler application is integrated into a client, server and network environment by providing for the process software to coexist with applications, operating systems and network operating systems software and then installing the process software on the clients and servers in the environment where the process software will function. The first step is to identify any software on the clients and servers including the network operating system where the process software will be deployed that are required by the process software or that work in conjunction with the process software. This includes the network operating system that is software that enhances a basic operating system by adding networking features. Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level. After ensuring that the software, where the process software is to be deployed, is at the correct version level that has been tested to work with the process software, the integration is completed by installing the process software on the clients and servers.

The process software is shared, simultaneously serving multiple customers in a flexible, automated fashion. It is standardized, requiring little customization and it is scalable, providing capacity on demand in a pay-as-you-go model. The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc. When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to effect the performance of that server, other servers are accessed to increase the capacity and to share the workload. Likewise when other measurements of use such as network bandwidth, memory usage, storage usage, etc. approach a capacity so as to effect performance, additional network bandwidth, memory usage, storage etc. are added to share the workload. The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider. In another embodiment, the service provider requests payment directly from a customer account at a banking or financial institution. In another embodiment, if the service provider is also a customer of the customer that uses the process software application, the payment owed to the service provider is reconciled to the payment owed by the service provider to minimize the transfer of payments.

The process software may be deployed, accessed and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid. The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software. When using the site-to-site VPN, the process software is deployed, accessed and executed through the use of dedicated equipment and large-scale encryption that are used to connect a companies multiple fixed sites over a public network such as the Internet. The process software is transported over the VPN via tunnelling which is the process the of placing an entire packet within another packet and sending it over a network. The protocol of the outer packet is understood by the network and both points, called tunnel interfaces, where the packet enters and exits the network.

What is claimed is:

1. A directory dialler method, said method being performed in an interactive voice response system having: a dialler application; a directory of telephone numbers and names; and text baseforms comprising phonetic units estimated from the text of each of the names in the directory so that each name is associated with at least one text baseform, said method comprising:
prompting a user to speak a name;
recording a spoken name in electronic form;
performing name recognition by estimating a recorded baseform from the recorded name to match baseforms associated with names in the directory;
determining the quality of the recognition;
performing the following steps if the quality of the recognition is below a predetermined level;
prompting the user to spell the letters of the spoken name;
performing recognition on the recorded letters to match a name in the directory; and
associating the recorded baseform with the matched name whereby the matched name is associated with both a recorded baseform and a text baseform.

2. A method as in claim 2 further comprising dialling the number corresponding with the matched name in the directory.

3. A method as in claim 1 wherein each time the quality of the recognition is below the predetermined level, the recorded spoken name is saved and a count taken, the recorded baseform is associated with the matched name when the count reaches a second predetermined level.

4. A method as in claim 3 wherein the recorded baseform for a name is built from a plurality of recordings for that name.

5. A method as in claim 4 wherein the recorded phonetic baseform is built from an average of the closest recordings for that name and the most different recordings are not used.

6. A directory dialler method, said method being performed in an interactive voice response system having a dialler application and a directory of telephone numbers and names, said method comprising:
prompting a user to speak a name;
recording a spoken name in electronic form;
performing speech recognition on the spoken name to match a name in the directory;
determining the quality of the match;
performing the following steps if the quality of the match is below a predetermined level;
prompting the user to spell the letters of the spoken name;
recording spoken letters of the name in electronic form;
performing recognition on the recorded letters to match with the letters of a name in the directory;
dialling the number corresponding with the name in the directory.

7. A method as in claim 6 further comprising the steps of:
building a text baseform from phonemes and using the text of each of the names in the directory so that each name has a corresponding text baseform;
building a recorded baseform from phonemes and the spoken recorded name; and
associating the recorded baseform to the name identified by the recognised letters.

8. A method as in claim 7 wherein each time the quality of the match is below the predetermined level, the recorded spoken name is saved and a count taken, the recorded phonetic baseform is being built when the count reaches a second predetermined level.

9. A method as in claim 8 where the recorded phonetic baseform for a name is built from a plurality of recording for that name.

10. A method as in claim 9 wherein the recorded phonetic baseform is built from an average of the closest recordings for that name.

11. An interactive voice response system comprising:
a directory of telephone numbers and names;
text baseforms comprising phonetic units estimated from the text of each of the names in the directory so that each name is associated with at least one text baseform;
means for prompting a user to speak a name;
means for recording a spoken name in electronic form;
means for performing name recognition by estimating a recorded baseform from the recorded name to match baseforms associated with names in the directory;
means for determining the quality of the recognition;
means for performing the following steps if the quality of the recognition is below a predetermined level;
means for prompting the user to spell the letters of the spoken name;
means for performing recognition on the recorded letters to match a name in the directory; and
means for associating the recorded baseform with the matched name whereby the matched name is associated with both a recorded baseform and a text baseform.

12. An interactive voice response system comprising:
a directory of telephone numbers and names;
means for prompting a user to speak a name;
means for recording a spoken name in electronic form;
means for performing speech recognition on the spoken name to match a name in the directory;
means for determining the quality of the match;
means for performing the following steps if the quality of the match is below a predetermined level;
means for prompting the user to spell the letters of the spoken name;
means for recording spoken letters of the name in electronic form;
means for performing recognition on the recorded letters to match with the letters of a name in the directory; and
means for dialling the number corresponding with the name in the directory.

13. A computer program product for an interactive voice response system, said interactive voice response system having: a dialler application; a directory of telephone numbers and names; and text baseforms comprising phonetic units estimated from the text of each of the names in the directory so that each name is associated with at least one text baseform, said computer program product comprising computer program instructions stored on a computer-readable storage medium for, when loaded into a computer and executed, causing a computer to carry out the steps of:
prompting a user to speak a name;
recording a spoken name in electronic form;
performing name recognition by estimating a recorded baseform from the recorded name to match baseforms associated with names in the directory;
determining the quality of the recognition;
performing the following steps if the quality of the recognition is below a predetermined level;
prompting the user to spell the letters of the spoken name;
performing recognition on the recorded letters to match a name in the directory; and
associating the recorded baseform with the matched name whereby the matched name is associated with both a recorded baseform and a text baseform.

14. A computer program product for an interactive voice response system, said interactive voice response system having: a dialler application; a directory of telephone numbers and names, said computer program product comprising computer program instructions stored on a computer-readable storage medium for, when loaded into a computer and executed, causing a computer to carry out the steps of:
prompting a user to speak a name;
recording a spoken name in electronic form;
performing speech recognition on the spoken name to match a name in the directory;
determining the quality of the match;
performing the following steps if the quality of the match is below a predetermined level;
prompting the user to spell the letters of the spoken name;
recording spoken letters of the name in electronic form;
performing recognition on the recorded letters to match with the letters of a name in the directory; and
dialling the number corresponding with the name in the directory.

15. A service, said service being performed in an interactive voice response system having: a dialler application; a directory of telephone numbers and names; and text baseforms comprising phonetic units estimated from the text of each of the names in the directory so that each name is associated with at least one text baseform, said service comprising:
prompting a user to speak a name;
recording a spoken name in electronic form;
performing name recognition by estimating a recorded baseform from the recorded name to match baseforms associated with names in the directory;
determining the quality of the recognition;
performing the following steps if the quality of the recognition is below a predetermined level;
prompting the user to spell the letters of the spoken name;
performing recognition on the recorded letters to match a name in the directory; and
associating the recorded baseform with the matched name whereby the matched name is associated with both a recorded baseform and a text baseform.

16. A directory dialler service, said service being performed in an interactive voice response system having a dialler application and a directory of telephone numbers and names, said service comprising:
prompting a user to speak a name;
recording a spoken name in electronic form;
performing speech recognition on the spoken name to match a name in the directory;
determining the quality of the match;
performing the following steps if the quality of the match is below a predetermined level;
prompting the user to spell the letters of the spoken name;
recording spoken letters of the name in electronic form;
performing recognition on the recorded letters to match with the letters of a name in the directory;
dialling the number corresponding with the name in the directory.
